(19) United States
(12) Patent Application Publication
(10) Pub. No.: US 2019/0118373 A1
(43) Pub. Date: Apr. 25, 2019

(54) PARALLEL ROBOTICS SYSTEM, COMPUTER PROGRAM THEREOF, AND METHOD FOR PROVIDING CONTENT SERVICE

(71) Applicant: ROLabs Inc., Siheung-si (KR)

(72) Inventors: Won Suk JEONG, Incheon (KR); Chang Uk KANG, Incheon (KR); Jin Hun KIM, Seoul (KR)

(21) Appl. No.: 16/101,696

(22) Filed: Aug. 13, 2018

(30) Foreign Application Priority Data
Oct. 19, 2017 (KR) 10-2017-0135874

(51) Int. Cl. B25J 9/00; B25J 17/02; B25J 9/16; H04N 21/2187

(52) U.S. Cl. CPC B25J 9/0075; B25J 9/0033; H04N 21/2187; B25J 9/1697; B25J 17/0275

(57) ABSTRACT

The parallel robotics system is disclosed. The parallel robotics system includes a base, a plurality of first active joints each moving independently from each other in a first direction in the base, a plurality of second active joints connected to the first active joints, respectively, and each moving independently from each other in a second direction perpendicular to the first direction, and a truss structure connected to the plurality of second active joints and moving depending on a movement of each of the plurality of first active joints and a movement of each of the plurality of second active joints.

### CROSS-REFERENCE TO RELATED APPLICATIONS

This application claims priority under 35 U.S.C. § 119 to Korean Patent Application No. 10-2017-0135874 filed on Oct. 19, 2017, the disclosure of which is incorporated by reference herein in its entirety.

### TECHNICAL FIELD

The present inventive concepts relate to a parallel robotics system, computer program thereof, and a method for providing content service.

### DISCUSSION OF RELATED ART

As compared to a conventional serial mechanism, a parallel mechanism represented by a Stewart-Gough platform has been of increasing interest not only in academia or research institutes but also in industries because of its advantages such as higher stiffness and higher speed, and has been studied in various fields such as a robot field for high-speed assembly, a multi-axis computer numerical control (CNC) machining field, and a virtual reality field such as a flight simulator.

As a study concerning a parallel mechanism, there are numerous research results on mathematical and analytical methodologies, instead of enhancing the advantages of the parallel mechanism, in many fields such as a kinematic analysis (forward kinematics and backward kinematics) problem inherently existing in the parallel mechanism, and a singular configuration analysis and interpretation that must be avoided to move the end effector of a robot.

A parallel robot using a conventional parallel mechanism has a structure that directly connects the links of a serial robot with the end effector by applying kinematic constraints to each other, and thereby enhancing a structural rigidity and increasing accuracy.

However, stress concentration often occurs at the joints of the parallel robot depending on a posture of the end effector of the robot, and stiffeners are used in the joints to overcome this problem when parallel robots are actually produced. This causes not only an increase in cost of a parallel robot but also an increase in size of the parallel robot.

### SUMMARY

An object of the present inventive concepts is to provide a parallel robotic system which has a self-load substantially equal to a self-load of a workpiece that can be connected to an end effector by dispersing the self-load of the workpiece that can be connected to the end effector to each of active joints, for example, first active joints and second active joints, coupled to each other, a computer program for operating the parallel robotics system, and a method of providing a content service including the parallel robotics system.

To this end, each of the first active joints is disposed in a base and moves independently from each other in a first direction, the second active joints each coupled with a corresponding active joint among the first active joints moves independently from each other in a second direction perpendicular to the first direction, and a truss structure is connected or coupled with the second active joints.

An exemplary embodiment of the present inventive concepts is directed to a parallel robotics system, including a base, first active joints each moving independently from each other in a first direction in the base, second active joints connected to the first active joints, respectively, and each moving independently from each other in a second direction perpendicular to the first direction, and a truss structure connected to the second active joints and moving depending on a movement of each of the first active joints and a movement of each of the second active joints.

Another exemplary embodiment of the present inventive concepts is directed to a non-transitory computer readable program stored in a data storage device to control a parallel robotics system in combination with hardware, including controlling each of first active joints such that each of the first active joints moves independently from each other in a first direction in a base of the parallel robotics system, and controlling each of second active joints connected to the first active joints, respectively, such that each of the second active joints moves independently from each other in a second direction perpendicular to the first direction, in which each of connecting devices connected between two corresponding second active joints among the second active joints moves depending on a movement of each of the plurality of first active joints and a movement of each of the plurality of second active joints.

Still another exemplary embodiment of the present inventive concepts is directed to a method of providing a content service using a content acquisition device, a server, and a parallel robotics system, including receiving, by the parallel robotics system, first content data from the server, generating, by the parallel robotics system, first control signals and second control signals on the basis of the first content data, controlling, by the parallel robotics system, each of first active joints using the first control signals such that each of the first active joints moves independently from each other in a first direction in a base of the parallel robotics system, and controlling, by the parallel robotics system, each of second active joints connected to the first active joints, respectively, using the second control signals such that each of the second active joints moves independently from each other in a second direction perpendicular to the first direction, in which each of connecting devices connected between two corresponding second active joints among the second active joints moves depending on a movement of each of the first active joints and a movement of each of the second active joints.

### BRIEF DESCRIPTION OF THE DRAWINGS

These and/or other aspects and advantages of the present general inventive concepts will become apparent and more readily appreciated from the following description of the embodiments, taken in conjunction with the accompanying drawings of which:

FIGS. 1A, 1B, 1C and 2 are schematic block diagrams of a parallel robotics system according to exemplary embodiments of the present inventive concepts, respectively;

FIGS. 3 and 4 are schematic block diagrams of a parallel robotics system according to exemplary embodiments of the present inventive concepts, respectively;

FIG. 5 is a block diagram which describes an operation of a control device for controlling components of the parallel robotics system shown in FIGS. 1A to 4;

FIG. 6 is a flowchart which describes an operation of a computer program shown in FIG. 5;

FIG. 7 is a schematic diagram of a system which provides a content service using a content acquisition device, a server, and a parallel robotics system; and

FIG. 8 is a flowchart which describes an operation of the system shown in FIG. 7.

### DETAILED DESCRIPTION OF THE EMBODIMENTS

Reference will be made in detail to the embodiments of the present general inventive concepts, examples of which are illustrated in the accompanying drawings, wherein like reference numerals refer to the like elements throughout. The embodiments are described below in order to explain the present general inventive concepts by referring to the figures.

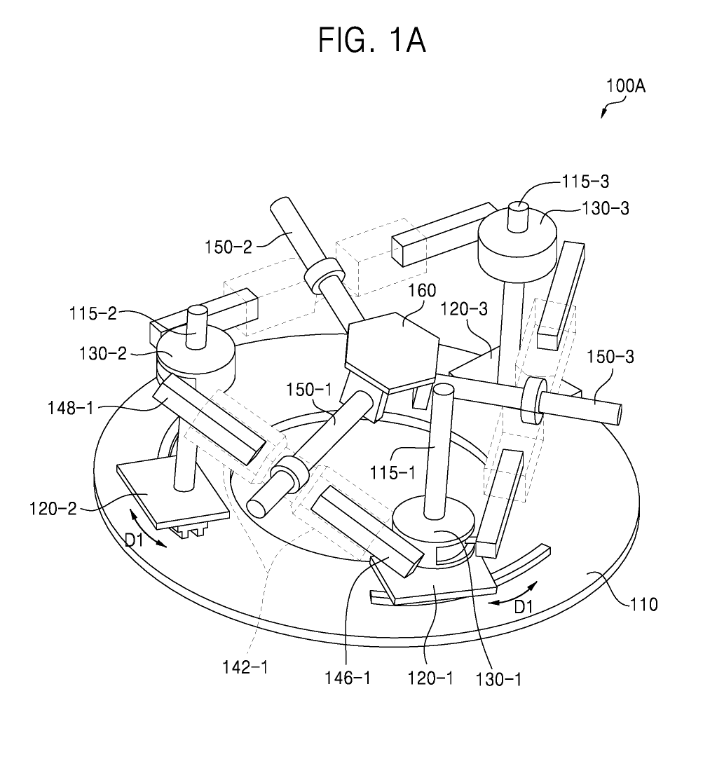

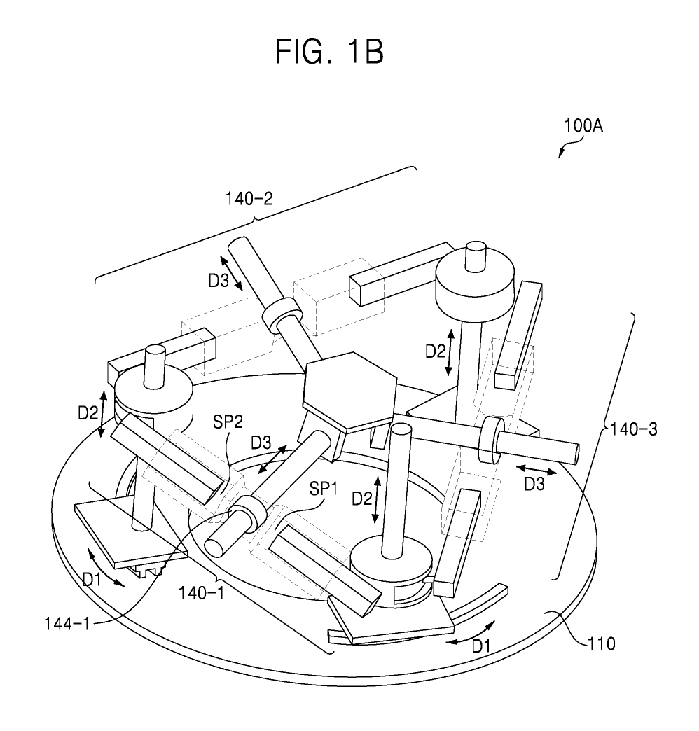

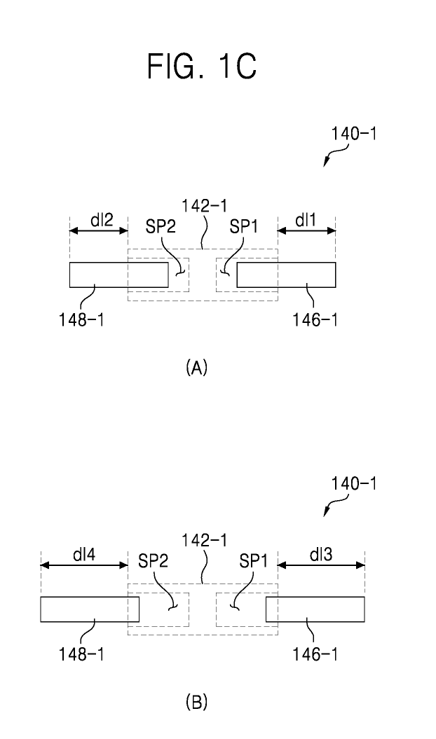

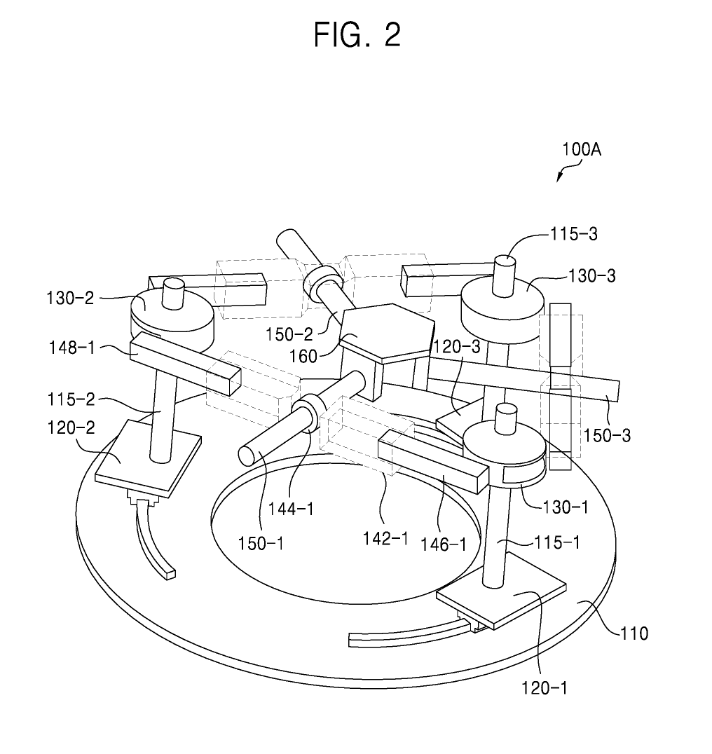

FIGS. 1A, 1B, 1C and 2 are schematic block diagrams of a parallel robotics system according to exemplary embodiments of the present inventive concepts, respectively. With reference to FIGS. 1A to 2, a parallel robotics system 100A or parallel mechanism 100A includes a base 110, first active joints 120-1 to 120-3, second active joints 130-1 to 130-3, and a truss structure.

The parallel robotics system (100A, 100B, or 100C: collectively referred to as 100) according to an exemplary embodiment of the present inventive concepts can disperse a self-load of a device or a workpiece that can be connected to an end effector 160 to each of the first active joints 120-1 to 120-3 and each of the second active joints 130-1 to 130-3 using a truss structure, and thereby making a ratio of a self-weight (or weight) of the device or the workpiece that can be connected to the end effector 160 to a self-weight (or weight) of the parallel robotics system 100 substantially equal to one.

According to exemplary embodiments, the parallel robotics system 100 may be embodied as a simulator for various simulations such as flight control, ship control, vehicle driving, or virtual reality.

The base 110 is also referred to as a base plate. Vertical frames 115-1 to 115-3 are connected to the first active joints 120-1 to 120-3, respectively. Each of the vertical frames 115-1 to 115-3 may be referred to as a ball screw, a ball screw shaft, or a screw axis.

Each of the first active joints 120-1 to 120-3 is connected or disposed to the base 110 and moves independently from each other in a first direction D1. The first direction D1 may be a horizontal direction or a concentric circle direction with respect to the center of the base 110. For example, each of the first active joints 120-1 to 120-3 may move independently from each other along a guide hole or a guide rail formed in the base 110.

Each of the first active joints 120-1 to 120-3 may be an active joint using a gear, but the present inventive concepts are not limited thereto. A direction in which an active joint 120-1 or 120-2 moves may be the same as or opposite to a direction in which an active joint 120-3 moves.

The second active joints 130-1 to 130-3 are connected to the first active joints 120-1 to 120-3 through each of the vertical frames 115-1 to 115-3, respectively, and each of the second active joints 130-1 to 130-3 moves independently from each other in a second direction D2 as shown in FIG. 1B. For example, the first direction D1 and the second direction D2 may be perpendicular to each other.

A direction in which an active joint 130-1 or 130-2 moves may be the same as or opposite to a direction in which an active joint 130-3 moves. Each of the second active joints 130-1 to 130-3 may move up or down along each of the vertical frames 115-1 to 115-3.

An active joint in the present specification may refer to a joint which includes an actuator (for example, a motor) capable of moving the active joint and an encoding device (for example, an encoder) for providing information on a position (or location) of the active joint at a specific time, and actively moves. A passive joint may refer to a joint which does not include the actuator and the encoding device, and passively moves in accordance with a movement (or motion) of an active joint.

According to exemplary embodiments, an active joint may be defined as a device including both the active joints and vertical frames. According to an exemplary embodiment, each of the second active joints 130-1 to 130-3 may be an active joint using a ball screw, but the present inventive concepts are not limited thereto.

The truss structure is connected to the second active joints 130-1 to 130-3, and moves depending on a movement (or motion) of each of the first active joints 120-1 to 120-3 and a movement (or motion) of each of the second active joints 130-1 to 130-3. That is, a movement (or motion) of the truss structure is determined in accordance with the movement (or the motion) of each of the first active joints 120-1 to 120-3 and the movement (or the motion) of each of the second active joints 130-1 to 130-3.

The truss structure includes connecting devices 140-1 to 140-3, rigid bodies 150-1 to 150-3, and an end effector 160. When the truss structure is a triangle or a regular (or an equilateral) triangle, each of the connecting devices 140-1 to 140-3 corresponds to each side of the triangle or the regular triangle.

Each of the connecting devices 140-1 to 140-3 is connected between two corresponding second active joints 130-1 and 130-2, 130-2 and 130-3, and 130-3 and 130-1 among the second active joints 130-1 to 130-3. Each of the connecting devices 140-1 to 140-3 moves depending on the movement of each of the first active joints 120-1 to 120-3 and the movement of each of the second active joints 130-1 to 130-3. According to exemplary embodiments, each of the active joints 120-1 to 120-3 and 130-1 to 130-3 may be a prismatic joint.

Each of the rigid bodies 150-1 to 150-3 is connected to each corresponding connecting device among the connecting devices 140-1 to 140-3. Each of the rigid bodies 150-1 to 150-3 may be embodied as a cylindrical rod, but the shape of each of the rigid bodies 150-1 to 150-3 is not limited to the cylindrical rod. According to exemplary embodiments, each of the connecting devices 140-1 to 140-3 may be embodied as a spherical joint.

The end effector 160 is connected to the rigid bodies 150-1 to 150-3. The end effector 160 may be referred to as a moving platform, and is not directly connected to each of the first active joints 120-1 to 120-3 and each of the second active joints 130-1 to 130-3.

Each of the connecting devices 140-1 to 140-3 includes a slider block including a passive joint (for example, a spherical joint), a first slider (for example, a passive joint), and a second slider (for example, a passive joint). Since each of the connecting devices 140-1 to 140-3 has the same structure and the same operation, the structure and operation of a first connecting device 140-1 will be described below.

A first slider block (or a fixed link 142-1) of the first connecting device 140-1 includes a passive joint 144-1, a first slider (or a first sliding link 146-1), and a second slider (or a second sliding link 148-1). Each of the sliders 146-1 and 148-1 may move (or rotate by a certain angle) in accordance with the movement of each of the first active joints 120-1 and 120-2 and/or the movement of each of the second active joints 130-1 and 130-2.

The passive joint 144-1 may be connected to the rigid body 150-1, and may be disposed (or installed) in the center of the first connecting device 140-1. The rigid body 150-1 may move in a third direction D3 by the passive joint 144-1 in accordance with a movement of the end effector 160 connected to the rigid body 150-1.

A first slider 146-1 is connected between one (for example, 130-1) of two second active joints 130-1 and 130-2 and the first slider block 142-1, and may move forward or backward in a first inner space SP1 of the first slider block 144-1 as shown in FIGS. 1B and 1C.

A second slider 148-1 is connected between the other (for example, 130-2) of two second active joints 130-1 and 130-2 and the first slider block 142-1, and may move forward or backward in a second inner space SP2 of the first slider block 144-1 as shown in FIGS. 1B and 1C.

As shown in (A) and (B) of FIG. 1C, lengths d11, d12, d13, and d14 of respective sliders 146-1 and 148-1 connected to the first slider block 142-1 increase or decrease when the first connecting device 140-1 is moved by two first active joints 120-1 and 120-2 and/or two second active joints 130-1 and 130-2.

For example, when the base 110 is parallel to the first connecting device 140-1 as shown in (A) of FIG. 1C, a variation amount d11 or d12 of the length of each slider 146-1 or 148-1 is a minimum. When the active joints 130-1 and 130-2 move up to an operating limit in opposite directions as shown in (B) of FIG. 1C, a variation amount d13 or d14 of the length of each slider 146-1 or 148-1 is a maximum.

The variation amount d11 of the length of the first slider 146-1 is the same as the variation amount d12 of the length of the second slider 148-1 at a first time or as shown in (A) of FIG. 1C. The variation amount d13 of the length of the first slider 146-1 is the same as the variation amount d14 of the length of the second slider 148-1 at a second time or as shown in (B) of FIG. 1C.

For example, FIG. 1A, FIG. 1B, and (A) of FIG. 1C show the operation of the parallel robotics system 100A at the first time, and FIG. 2 and (B) of FIG. 1C show the operation of the parallel robotics system 100A at the second time which is different from the first time.

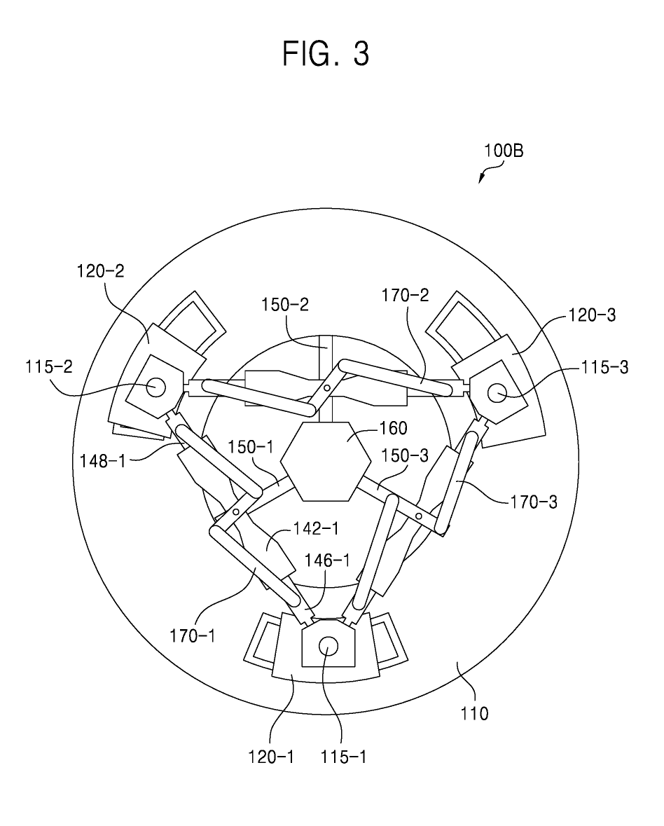

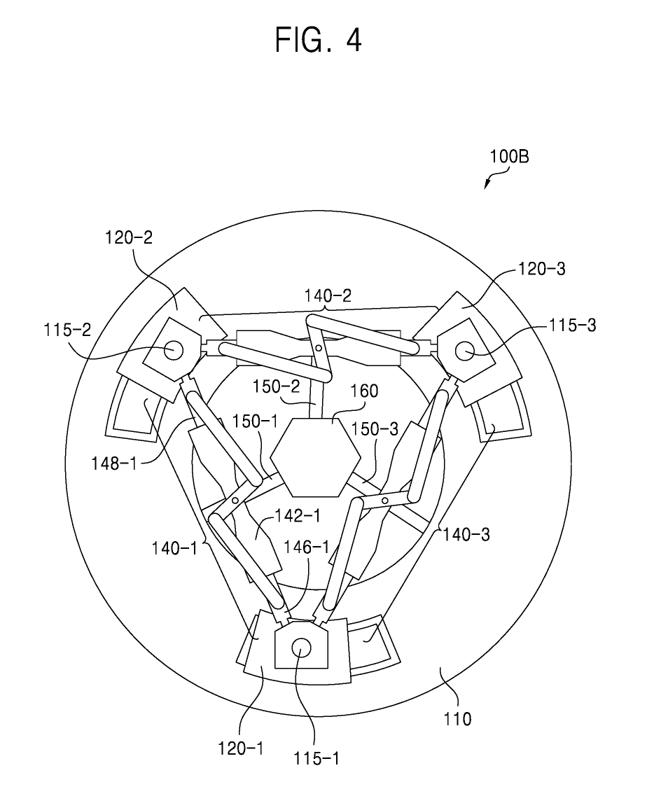

Each of FIGS. 3 and 4 is a schematic block diagram of a parallel robotics system according to exemplary embodiments of the present inventive concepts. With reference to FIGS. 1A to 4, a parallel robotics system 100B includes components of the parallel robotics system 100A and further includes adjusting devices 170-1 to 170-3. Each of the adjusting devices 170-1 to 170-3 may be embodied as a scotch yoke, but the present inventive concepts are not limited thereto.

Each of the adjusting devices 170-1 to 170-3 is connected to each slider block 142-1, each first slider 146-1, and each second slider 148-1. Each of the adjusting devices 170-1, 170-2, and 170-3 performs a function of adjusting each of the connecting devices 140-1 to 140-3 such that each slider block 142-1 is positioned at the center or a center point of the second active joints 130-1 and 130-2, 130-2 and 130-3, and 130-3 and 130-1.

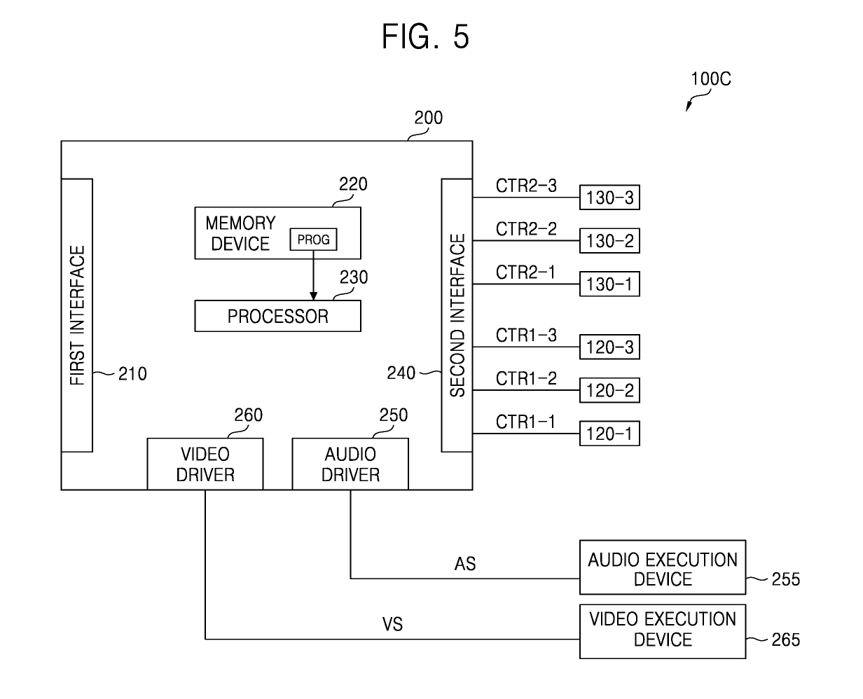

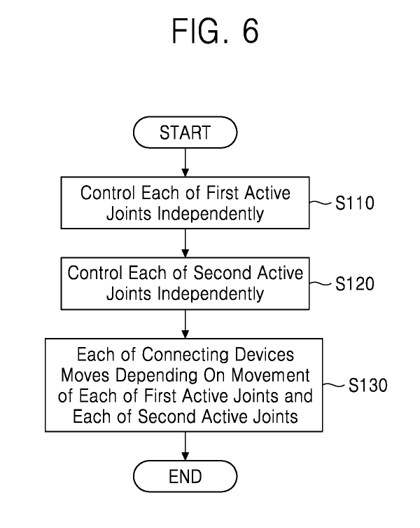

FIG. 5 is a block diagram for describing the operation of a control device for controlling components of the parallel robotics system shown in FIGS. 1A to 4, and FIG. 6 is a flowchart which describes an operation of a computer program shown in FIG. 5.

A parallel robotics system 100C includes the components of the parallel robotics system 100A or 100B and further includes a control device 200. According to exemplary embodiments, the parallel robotics system 100C may further include an audio execution device 155 and/or a video execution device 265.

A computer program PROG is stored in a data storage device 220, for example, a memory device 220, in combination with hardware 200 or 100C to control the parallel robotics system 100C. When the control device 200 is executed or booted, the computer program PROG is loaded from the memory device 220 onto or into a processor 230.

The memory device 220 collectively refers to a non-volatile memory device and a volatile memory device; the non-volatile memory device includes a hard disk drive (HDD), a solid state drive (SSD), or a flash memory-based device, and the volatile memory device includes a random access memory (RAM), a static RAM (SRAM), or a dynamic RAM (DRAM).

Although the memory device 220 is shown outside the processor 230, the memory device 220 may refer to a memory device embodied inside the processor 230. The memory device 220 refers to a memory device related to the operation of the computer program PROG regardless of a type or a disposed position of the memory device 220.

The control device 200 includes a first interface 210, a memory device 220, a processor 230, and a second interface 240, and may further include an audio driver 250 and/or a video driver 260 according to exemplary embodiments.

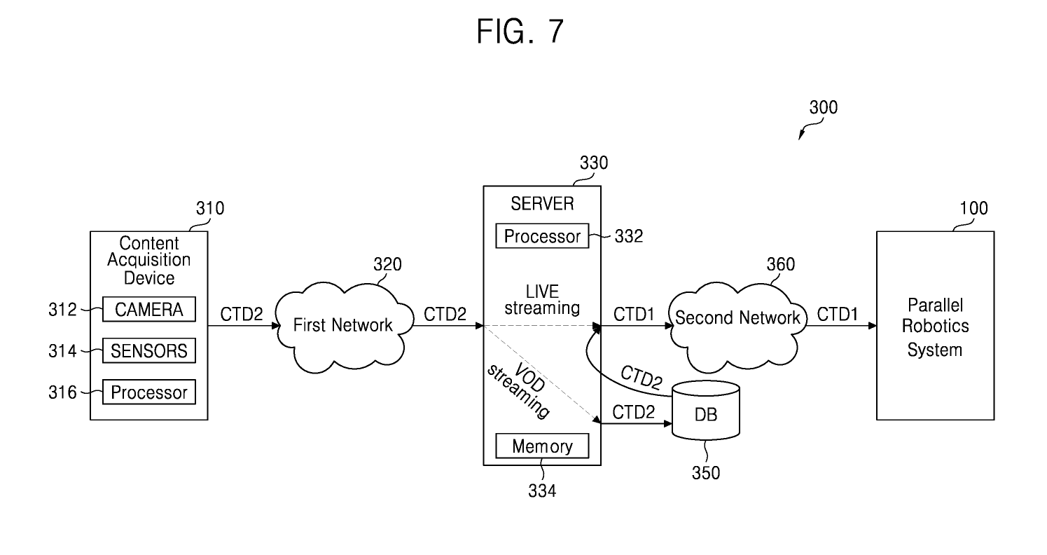

The first interface 210 is an interface for communication with a host device, and may perform a function of transmitting or receiving signals (or data) to or from a server 330 through a second communication network 360 as shown in FIG. 7.

The memory device 220 may store the computer program PROG and data for the operations of the control device 200. In an exemplary embodiment, the memory device 220 may serve as a non-transitory computer-readable storage medium 220 that is operable with a control device 200. The non-transitory computer-readable storage medium 220 may store the computer program PROG.

The processor 230 may execute the computer program PROG, and may control operations of the components 210, 220, 240, 250, and 260. First control signals CTR1-1 to CTR1-3 and second control CTR2-1 to CTR2-3 generated by the processor 230 or the computer program PROG executed by the processor 230 are transmitted to the first active joints 120-1 to 120-3 and the second active joints 130-1 to 130-3 through the second interface 240. Each of the active joints 120-1 to 120-3 and 130-1 to 130-3 moves independently in accordance with each of the control signals CTR1-1 to CTR1-3 and CTR2-1 to CTR2-3.

A computer program product comprises a computer readable storage medium (for example, the memory device 220) having a computer readable program (for example, the computer program PROG) stored therein, wherein the computer readable program, when executed on a computing device (for example, control device 200 or a processor 230), causes the computing device to control each of a plurality of first active joints such that each of the plurality of first active joints moves independently from each other in a first direction in a base of the parallel robotics system and to control each of a plurality of second active joints connected to the plurality of first active joints, respectively, such that each of the plurality of second active joints moves independently from each other in a second direction perpendicular to the first direction. Each of a plurality of connecting devices connected between two corresponding second active joints among the plurality of second active joints moves depending on a movement of each of the plurality of first active joints and a movement of each of the plurality of second active joints.

The control device 200 or the computer program PROG controls each of the first active joints 120-1 to 120-3 such that each of the first active joints 120-1 to 120-3 attached or connected to the base 110 of the parallel robotics system 100C moves independently from each other in the first direction D1 (S110).

The control device 200 or the computer program PROG controls each of the second active joints 130-1 to 130-3 such that each of the second active joints 130-1 to 130-3 connected to each of the first active joints 120-1 to 120-3 moves independently in the second direction D2 (S120).

Each of the connecting devices 140-1 to 140-3 connected between two corresponding second active joints 130-1 and 130-2, 130-2 and 130-3, and 130-3 and 130-1 among the second active joints 130-1 to 130-3 moves depending on each of the first active joints 120-1 to 120-3 moving independently and each of the second active joints 130-1 to 130-3 moving independently.

The control device 200 or the computer program PROG controls the first interface 210 of the parallel robotics system 100C to receive movement data from a host device connected to the parallel robotics system 100C. The movement data may refer to motion date.

The control device 200 or the computer program PROG may generate the first control signals CTR1-1 to CTR1-3 for controlling the movement of each of the first active joints 120-1 to 120-3 using the movement data transmitted from the host device and generate the second control signals CTR2-1 to CTR2-3 for controlling the movement of each of the second active joints 130-1 to 130-3 using the movement data transmitted from the host device.

The movement data transmitted from the host device may be movement data which is live streamed from a content acquisition device communicating with the host device, or movement data which is video on demand (VOD) streamed by the host device after being stored in a database accessed by the host device.

According to exemplary embodiments, when the parallel robotics system 100C further includes sensors, the control device 200 or the computer program PROG may generate movement data using sensing signals output from the sensors, and generate the first control signals CTR1-1 to CTR1-3 and the second control signals CTR2-1 to CTR2-3 using the movement data.

The sensors may include an image sensor for generating color image information, a depth sensor for generating depth (or distance) information, a sensor for generating both color image information and depth information, and a sensor for generating information on an angular velocity and information on acceleration of the moving parallel robotics system 100C.

When the parallel robotics system 100C further includes an audio execution device 255 and a video execution device 265, the control device 200 or the computer program PROG may control the first interface 210 of the parallel robotics system 100C to receive audio data and video data along with the movement data from a host device.

The control device 200 or the computer program PROG may control an output of an audio signal (AS) generated using the audio data to the audio execution (or reproducing) device 255 and/or an output of a video signal (VS) generated using the video data to the video execution (or reproducing) device 265.

The audio driver 250 for generating an audio signal (AS) using the audio data may be embodied as a hardware device or a part of the computer program PROG.

The video driver 260 for generating a video signal (VS) using the video data may be embodied as a hardware device or a part of the computer program PROG. The control device 200 or the computer program PROG may transmit the audio data to the audio driver 250 and transmit the video data to the video driver 260.

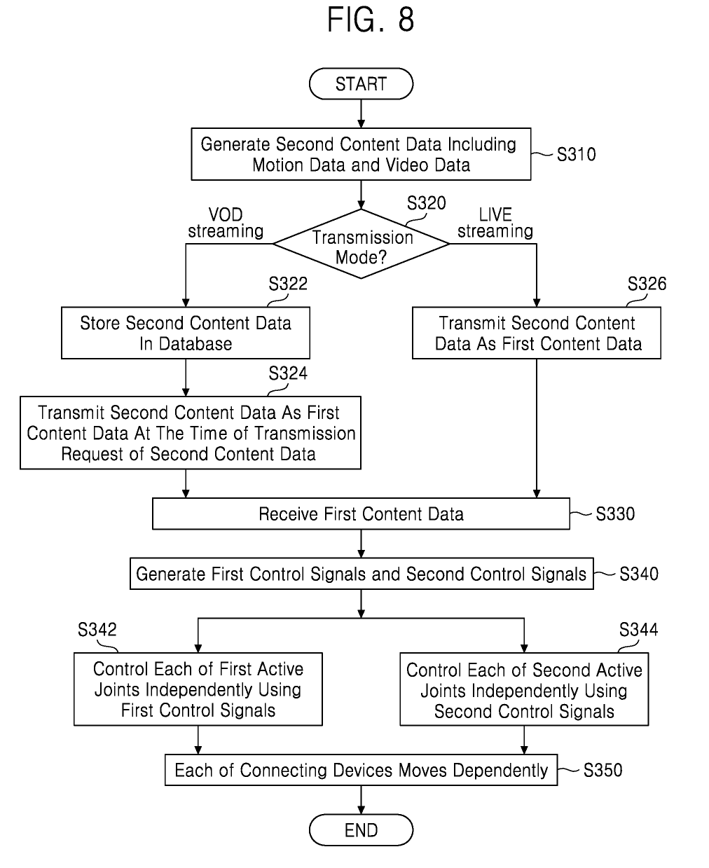

FIG. 7 is a schematic diagram of a system providing a content service using a content acquisition device, a server, and a parallel robotics system, and FIG. 8 is a flowchart which describes an operation of the system shown in FIG. 7.

With reference to FIGS. 1A to 8, a content service providing system 300 providing a content (or contents) service includes a content acquisition device 310, a server 330, and a parallel robotics system 100. The parallel robotics system 100 may collectively refer to each parallel robotics system 100A, 100B, or 100C.

The content acquisition device 310 and the server 330 may transmit or receive signals (information or data) to or from each other through a first communication network 320, and the server 330 and the parallel robotics system 100 may transmit or receive signals (information or data) to or from each other through a second communication network 360. The first communication network 320 may be the Internet or a Wi-Fi network, but the present inventive concepts are not limited thereto. The second communication network 360 may be a wired communication network or a Bluetooth communication network, but the present inventive concepts are not limited thereto.

The content acquisition device 310 may refer to an apparatus capable of generating second content data CTD2 including visual (or video) data and/or audio data. The content acquisition device 310 includes a camera 312, a plurality of sensors 314, and a processor 316.

The camera 312 may generate video data (for example, still images or moving images), the sensor 314 may generate information on an angular velocity and/or information on acceleration of the content acquisition device 310, and the processor 316 may control the operations of the camera 312 and the sensors 314. The sensors 314 include a device for generating audio information.

The processor 316 may generate motion data representing a motion of the content acquisition device 310 using the information on an angular velocity and/or the information on acceleration output from the sensors 314. The processor 316 may generate the second content data CTD2 by synchronizing the video data (video data including audio data according to an exemplary embodiment) with the motion data, and transmit the second content data CTD2 to the first communication network 320.

In a method of providing a content service using the content acquisition device 310, the server 330, and the parallel robotics system 100, the parallel robotics system 100 receives first content data CTD1 from the server 330 (S330).

The parallel robotics system 100 may generate the first control signals CTR1-1 to CTR1-3 and the second control signals CTR2-1 to CTR2-3 on the basis of the first content data CTD1 or using motion data included in the first content data CTD1 (S340).

The parallel robotics system 100 may control each of the first active joints 120-1 to 120-3 using the first control signals CTR1-1 to CTR1-3 such that each of the first active joints 120-1 to 120-3 disposed or connected in the base 110 of the parallel robotics system 100 moves independently from each other in the first direction D1 (S342).

The parallel robotics system 100 may control each of the second active joints 130-1 to 130-3 using the second control signals CTR2-1 to CTR2-3 such that each of the second active joints 130-1 to 130-3 connected to the first active joints 120-1 to 120-3, respectively, moves independently from each other in the second direction D2 (S344). The first direction D1 and the second direction D2 may be perpendicular to each other at each time.

Each of the connecting devices 140-1 to 140-3 connected between two corresponding second active joints 130-1 and 130-2, 130-2 and 130-3, and 130-3 and 130-1 among the second active joints 130-1 to 130-3 moves depending on the movement of each of the first active joints 120-1 to 120-3 and the movement of each of the second active joints 130-1 to 130-3 (S350).

In the method of providing a content service, the content acquisition device 310 generates video data using the camera 312, measures or calculates the angular velocity and acceleration of the content acquisition device 310, generates motion data corresponding to a result of the measurement, generates second content data CTD2 by synchronizing the video data with the motion data, and transmits the generated second content data CTD2 to the server 330 (S310). According to exemplary embodiments, when the sensors 314 are sensors for generating audio and video data, the second content data CTD2 may include motion data, video data, and audio data which are synchronized with one another.

In the method of providing a content service, the server 330 transmits the second content data CTD2 to the parallel robotics system 100 as first content data CTD1 (S330).

In the method of providing a content service, a processor 332 of the server 330 analyzes or determines a transmission mode signal stored in a memory device 334 (S320). When the transmission mode signal is a signal indicating live streaming, the processor 332 live streams the second content data CTD2 transmitted from the content acquisition device 310 to the parallel robotics system 100 as first content data CTD1 (S326).

However, in the method of providing a content service, when the transmission mode signal is a signal indicating VOD streaming, the processor 332 stores the second content data CTD2 transmitted from the content acquisition device 310 in a database 350 (S322). The processor 332 searches or retrieves for the second content data CTD2 from the database 350 and VOD streams the searched second content data CTD2 as first content data CTD1 through the second communication network 360 in response to a VOD data transmission request transmitted from the parallel robotics system 100 (S324).

When the parallel robotics system 100 further includes a head mounted display (HMD) 265 as the video execution device 265, the parallel robotics system 100 extracts video data and motion data from the first content data CTD1, generates the first control signals CTR1-1 to CTR1-3 and the second control signals CTR2-1 to CTR2-3 using the extracted motion data, and transmits a video signal (VS) corresponding to the extracted video data to the HMD 265 in the method of providing a content service. As described above, a method of providing a content service performed in the parallel robotics system 100 may be performed under control of a program PROG.

The parallel robotics system according to exemplary embodiments of the present inventive concepts can disperse a self-load of a workpiece which can be connected to an end effector to each of active joints (for example, first active joints and second active joints) coupled to each other.

Therefore, a ratio of a self-load of a workpiece which can be connected to an end effector to a self-load of the parallel robotics system (that is, a self-weight of the parallel robotics system) can be substantially equal to one (1) in the parallel robotics system.

Although a few embodiments of the present general inventive concepts have been shown and described, it will be appreciated by those skilled in the art that changes may be made in these embodiments without departing from the principles and spirit of the general inventive concepts, the scope of which is defined in the appended claims and their equivalents.

What is claimed is:

1. A parallel robotics system comprising:
a base;
a plurality of first active joints each moving independently from each other in a first direction;
a plurality of second active joints connected to the plurality of first active joints, respectively, and each moving independently from each other in a second direction perpendicular to the first direction; and
a truss structure connected to the plurality of second active joints, and moving depending on a movement of each of the plurality of first active joints and a movement of each of plurality of the second active joints.

2. The parallel robotics system of claim 1, wherein each of the plurality of first active joints is an active joint using a gear.

3. The parallel robotics system of claim 1, wherein each of the plurality of second active joints is an active joint using a ball screw.

4. The parallel robotics system of claim 1,
wherein the truss structure includes:
a plurality of connecting devices each connected between two corresponding second active joints among the plurality of second active joints and each moving depending on a movement of each of the plurality of first active joints and a movement of each of the plurality of second active joints;
a plurality of rigid bodies connected to the plurality of connecting devices, respectively; and
an end effector connected to each of the plurality of rigid bodies.

5. The parallel robotics system of claim 4, wherein a length of each of the plurality of connecting devices varies depending on the movement of each of the plurality of first active joints and the movement of each of the plurality of second active joints.

6. The parallel robotics system of claim 4,
wherein each of the plurality of connecting devices includes:
a slider block including a passive joint connected to a corresponding one of the plurality of rigid bodies;
a first slider connected between one of the two corresponding second active joints and the slider block, and capable of moving along a first internal space of the slider block; and
a second slider connected between the other of the two corresponding second active joints and the slider block, and capable of moving along a second internal space of the slider block.

7. The parallel robotics system of claim 6, wherein a variation amount of a length of the first slider is the same as a variation amount of a length of the second slider.

8. The parallel robotics system of claim 6, wherein each of the plurality of connecting devices further includes a scotch yoke connected to the slider block, the first slider, and the second slider.

9. A non-transitory computer-readable program stored in a data storage device to control a parallel robotics system in combination with hardware, the computer-readable program comprising:
controlling each of a plurality of first active joints such that each of the plurality of first active joints moves independently from each other in a first direction in a base of the parallel robotics system; and
controlling each of a plurality of second active joints connected to the plurality of first active joints, respectively, such that each of the plurality of second active joints moves independently from each other in a second direction perpendicular to the first direction,
wherein each of a plurality of connecting devices connected between two corresponding second active joints among the plurality of second active joints moves depending on a movement of each of the plurality of first active joints and a movement of each of the plurality of second active joints.

10. The computer-readable program of claim 9, further comprising:
controlling the parallel robotics system to receive motion data from a server connected to the parallel robotics system; and
generating a plurality of first control signals for controlling the movement of each of the plurality of first active joints and generating a plurality of second control signals for controlling the movement of each of the plurality of second active joints using the motion data.

11. The computer-readable program of claim 10,
wherein the motion data is motion data live streamed from a content acquisition device communicating with the server, or motion data video on demand (VOD) streamed by the server after being stored in a database accessed by the server.

12. The computer-readable program of claim 10, further comprising:
wherein when the parallel robotics system further includes an audio reproducing device and a video reproducing device,
controlling the parallel robotics system to receive audio data and video data together with the motion data from the server;
outputting audio signals generated using the audio data to the audio reproducing device; and
outputting video signals generated using the video data to the video reproducing device.

13. A method of providing a content service using a content acquisition device, a server, and a parallel robotics system, the method comprising:
receiving, by the parallel robotics system, first content data from the server;
generating, by the parallel robotics system, a plurality of first control signals and a plurality of second control signals on the basis of the first content data;
controlling, by the parallel robotics system, each of a plurality of first active joints using the plurality of first control signals such that each of the plurality of first active joints moves independently from each other in a first direction in a base of the parallel robotics system; and
controlling, by the parallel robotics system, each of a plurality of second active joints connected to the plurality of first active joints, respectively, using the plurality of second control signals such that each of the plurality of second active joints moves independently from each other in a second direction perpendicular to the first direction,
wherein each of a plurality of connecting devices connected between two corresponding second active joints among the plurality of second active joints moves depending on a movement of each of the plurality of first active joints and a movement of each of the plurality of second active joints.

14. The method of claim 13, further comprising:
generating video data using a camera of the content acquisition device;
measuring an angular velocity and acceleration of the content acquisition device using sensors of the content acquisition device, and generating motion data corresponding to a result of the measurement;
generating second content data by synchronizing the video data with the motion data using the content acquisition device, and transmitting the second content data to the server; and
transmitting, by the server, the second content data to the parallel robotics system as the first content data.

15. The method of claim 14,
wherein transmitting the second content data as the first content data is storing, by the server, the second content data in a database as the first content data for VOD streaming, or live streaming the second content data to the parallel robotics system as the first content data.

16. The method of claim 14, further comprising:
wherein when the parallel robotics system further includes a head mounted display (HMD),
extracting, the parallel robotics system, the video data and the motion data from the first content data;
generating, by the parallel robotics system, the plurality of first control signals and the plurality of second control signals using the motion data; and
transmitting, by the parallel robotics system, the video data to the HMD.
